(19) United States
(12) Patent Application Publication
(10) Pub. No.: US 2010/0250328 A1
(43) Pub. Date: Sep. 30, 2010

(54) BUSINESS ASSESSMENT METHOD

(75) Inventors: Ali P. Arsanjani, Fairfield, IA (US); Graham Paul Bate, Gaithersburg, MD (US); Edward H. B. Giesen, Bilthoven (NL); Thomas Franklin Guinan, Bethesda, MD (US); Raman Harishankar, Blacklick, OH (US); Kerrie Lamont Holley, Montara, CA (US); Jorge L. C. Sanz, Carmel, CA (US); Sham Madhukar Vaidya, Troy, MI (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 12/411,741

(22) Filed: Mar. 26, 2009

(51) Int. Cl. G06Q 10/00

(52) U.S. Cl. 705/10; 705/7

(57) ABSTRACT

An assessment of a business is performed using a computer implemented tool to provide a strategy model, an operating model, and an IT model. The assessment is performed by a services providing company for a client company. The assessment is used to create a SOA solution for the business. The services providing company may also implement the SOA solution for the business.

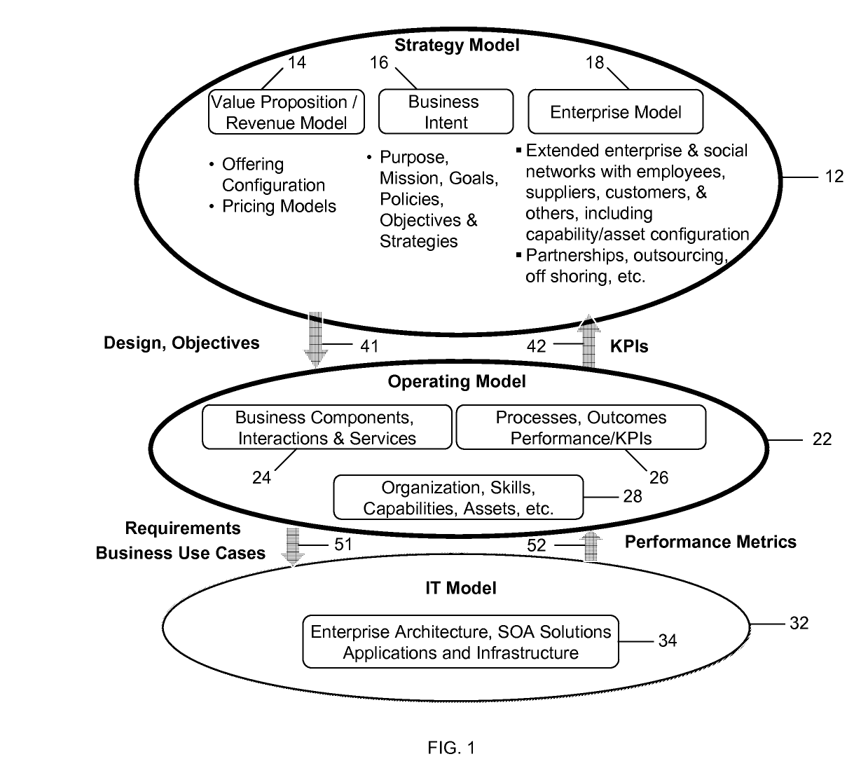

### CROSS REFERENCE TO RELATED APPLICATIONS

The present application is related to applications Ser. No. ______, filed ______, entitled, “A SYSTEM FOR IMPLEMENTING BUSINESS TRANSFORMATION IN AN ENTERPRISE”, which shall be incorporated herein by reference in its entirety.

The present application is related to applications Ser. No. ______, filed ______, entitled, “METHOD FOR TRANSFORMING AN ENTERPRISE BASED ON LINKAGES AMONG BUSINESS COMPONENTS, BUSINESS PROCESSES AND SERVICES”, which shall be incorporated herein by reference in its entirety.

### BACKGROUND OF THE INVENTION

1. Field of the Invention

The invention relates to novel methods of assessing the operation of a business enterprise. More specifically, a computer implemented tool is used to perform the assessment using strategy, operating, and information technology models incorporated within the tool. Unique linkages between the models assist in personalizing the models for a particular client business enterprise.

2. Description of the Related Art

An operating model includes business components. Component Business Modeling techniques are described by Rackham is US 2005/0203784, filed Mar. 9, 2004, which is herein incorporated by reference in its entirety. A computer implemented tool for use in practicing such techniques is described in the application “A SYSTEM FOR IMPLEMENTING BUSINESS TRANSFORMATION IN AN ENTERPRISE” noted above. Service Oriented Modeling and Architecture (SOMA) techniques as described by Cherbakov et al in US 2008/0027784, filed Jul. 31, 2006, may also be included in an operating model. Additional SOMA techniques are also described in US 2008/0126147, filed Jul. 31, 2006, and US 2008/0270201, filed Apr. 30, 2007. Each of these three SOMA applications are herein incorporated by reference in their entireties.

A company may perform consulting work for a client business enterprise. Such consulting work may be directed to transforming the enterprise by implementing a Service Oriented Architecture (SOA) information technology solution for the client. In order to create this solution, an assessment must be done of the client's business enterprise.

Because of the large investments needed and risks involved in transforming the enterprise, it is important to use the latest assessment techniques, which have been found to lead to efficient workable SOA solutions. An improvement in such assessment techniques would therefore constitute a significant improvement in the business assessment arts.

### OBJECTS AND SUMMARY OF THE INVENTION

It is therefore a principal object of the present invention to provide a computer implemented method for performing assessment of a business enterprise.

It is a further object of the invention to provide such a method which supports assessments involving a strategy model, an operating model, and an information technology model and linkages therebetween.

These and other objects are attained in accordance with one embodiment of the invention in which there is provided a method of assessing a business, comprising the steps of; constructing using a computer implemented tool a strategy model having a value proposition revenue model, a business intent, and an enterprise model, constructing using a computer implemented tool an operating model having business components, interactions, and services, process outcomes, and performance KPIs, and organization, skills, capabilities, and assets, constructing using a computer implemented tool, an IT model having enterprise architecture, SOA solution, applications and infrastructure, wherein the strategy model depends upon the KPIs in the operating model and provides design objectives to the operating model which depends therefrom, wherein the IT model depends upon requirements and business use cases provided by the operating model and the IT model provides performance metrics to the operating model which depends therefrom.

### BRIEF DESCRIPTION OF THE SEVERAL VIEWS OF THE DRAWINGS

The FIGURE illustrates the three models and linkages therebetween.

### DETAILED DESCRIPTION OF THE INVENTION

A services providing company performs an assessment of a business as a consulting service to the business. The business is analyzed. A strategy model 12, and operating model 22, and an IT model 32 are constructed for the business as depicted in the FIGURE.

Strategy model 12 includes a value proposition revenue model 14 which may include an offering configuration and pricing model. Value proposition revenue model 14 is implemented on a computer preferably using spreadsheet software to describe the financial design objectives 41 of the business.

Strategy model 12 includes a statement of the business' intent 16, specifically its purpose, mission, goals, policies, objectives, and strategies.

Strategy model 12 also includes an enterprise model 18 implemented on a computer, such as through use of spreadsheet software and personal networking software to extend these network techniques to employees, suppliers, and customers. Enterprise model 18 is dependent upon at least one Key Performance Indicator (KPI) from an operating model 22.

Operating model 22 includes business components 24, interactions, and services which are created using a computer implemented tool, such as the tool described in patent application titled, “A SYSTEM FOR IMPLEMENTING BUSINESS TRANSFORMATION IN AN ENTERPRISE”, cited above, which depends upon design objectives 41. Operating model 22, also includes processes, outcomes, and performance KPIs 26. The KPIs are provided to strategy model 12 via linkage 42.

Linkage 42 may be any method of providing data from one model to a second model, such as through a common variable if both models are implemented on a common computer system. Linkage 42 may also comprise a data connection between two computer systems, such as via telecommunication, a serial or parallel bus, modem, or any other method of data sharing.

Operating model 22 also includes a statement of organization, skills, capabilities, and assets 28.

IT model 32 receives requirements and business use cases over linkage 51 from the operating model, such as from a CBM map computer implemented tool.

IT model 32 includes enterprise architecture, SOA solutions, applications, and infrastructure 34. The IT model sends out performance metrics over linkage 52 to operating model 22, which uses such in the creation of operating model 22.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of assessing a business, comprising the steps of:
constructing, using a computer implemented tool, a strategy model having a value proposition revenue model, a business intent, and an enterprise model;
constructing, using a computer implemented tool, an operating model having business components, interactions, and services; processes outcomes, and performance KPIs; and organization, skills, capabilities, and assets;
constructing, using a computer implemented tool, an IT model having enterprise architecture, SOA solution, applications and infrastructure;
wherein said strategy model depends upon said KPIs in said operating model and provides design objectives to said operating model which depends therefrom; and
wherein said IT model depends upon requirements and business use cases provided by said operating model, and said IT model provides performance metrics to said operating model which depends therefrom.

2. The method assessing of claim 1, further comprising the step of delivering said strategy model, said operating model, and said IT model to said business.

3. The method of assessing of claim 1, further comprising generating an SOA solution plan for said business and delivering said plan to said business.

4. The method of assessing of claim 3, further comprising implementing said plan for said business.
